(19) United States
(12) Patent Application Publication
(10) Pub. No.: US 2017/0232862 A1
(43) Pub. Date: Aug. 17, 2017

(54) ELECTRIC DRIVE SYSTEM AND METHOD FOR OPERATING AN ELECTRIC MACHINE FOR AN ELECTRIC VEHICLE

(71) Applicant: Robert Bosch GmbH, Stuttgart (DE)

(72) Inventors: Christoph Woll, Gerlingen (DE); Klaus Beulich, Weil Der Stadt (DE); Waleed Sahhary, Sindelfingen (DE)

(21) Appl. No.: 15/518,534

(22) PCT Filed: Aug. 27, 2015
(86) PCT No.: PCT/EP2015/069614

§ 371 Date: Apr. 12, 2017

(30) Foreign Application Priority Data
Oct. 15, 2014 (DE) 10 2014 220 834.3

(51) Int. Cl. B60L 11/18; H02P 27/06; H02M 7/487; B60L 15/20

(52) U.S. Cl. CPC B60L 11/1853; B60L 11/1868; B60L 15/2045; H02P 27/06; H02M 7/487

(57) ABSTRACT

The invention relates to an electric drive system and to a method for operating an electric machine, in which the electric machine is controlled in a first operating mode using a first voltage. In order to temporarily increase the power, the electric machine can also be controlled in a second operating mode, in which the voltage used for the control is increased by an additional energy source.

### BACKGROUND OF THE INVENTION

The present invention relates to an electric drive system, a motor vehicle having an electric drive system and a method for operating an electric machine.

Various concepts are known in order to achieve a good acceleration whilst simultaneously achieving a high final velocity in the case of electric vehicles, such as for example electrically driven passenger cars. By way of example, the electric machine can be coupled to the wheels by way of a two-speed gearbox. Furthermore, it is also known in the case in particular of sports or high performance electric vehicles to dimension the electric machine in an accordingly large manner in order to also be able to provide a sufficient torque in the case of high rotational speeds.

Furthermore, DE 10 2011 056 012 A1 describes a drive train for an electric vehicle having two separate electric machines, wherein a first machine is designed for a higher maximum torque in comparison to the electrical second machine but is designed for a lower maximum rotational speed.

Owing to increasing further development in the field of electrical drive systems, in particular for electric vehicles, there is a demand for cost-effective, efficient electric drive systems that are capable of providing a boost.

### SUMMARY OF THE INVENTION

For this purpose, the present invention provides in accordance with a first aspect an electric drive system having an electrical energy storage device that comprises a first electrical energy storage apparatus and a second electrical energy storage apparatus; an electric machine; and an inverter that is designed for the purpose of controlling in a first operating mode the electric machine when using a first voltage that is provided by the first energy storage apparatus, and controlling in a second operating mode the electric machine when using a second voltage that occurs as a result of a series circuit of the first energy storage apparatus and the second energy storage apparatus.

In accordance with a further aspect, the present invention provides a method for operating an electric machine, said method having the steps of providing an electrical energy storage device that comprises a first electrical energy storage apparatus and a second electrical energy storage apparatus, controlling the electric machine in a first operating mode when using a first voltage that is provided by the first energy storage apparatus, and controlling the electric machine in a second operating mode when using a second voltage that occurs as a result of a series circuit of the first energy storage apparatus and second energy storage apparatus.

The present invention is based on the idea of controlling an electric machine in an electric drive system with different voltages in dependence upon the currently required power demand. In the case of low rotational speeds or lower power demand, the electric machine can be controlled by a lower electrical voltage from a suitable energy storage apparatus. In order to increase power, in particular in the case of high rotational speeds, it is furthermore possible by means of combining the energy storage apparatus with a further energy storage apparatus for the voltage to be increased so as to control the electric motor.

It is possible in this manner, even in the case of a low power demand, to control the electric machine in an efficient operating point. Consequently, in the case of a low power demand a particularly high degree of efficiency is achieved that is greater than the degree of efficiency of a conventional drive system in a part load operation.

In the case of an intense power demand, for example for an intense acceleration in the case of high rotational speeds or for the drive of an electric vehicle in the case of relatively high velocities, it is furthermore possible by virtue of an additional energy storage apparatus to increase the voltage for controlling the electric machine. By way of example, for this purpose multiple energy storage apparatuses are connected in series so that the sum of the terminal voltages of the individual energy storage apparatuses is available for controlling the electric machine.

Consequently, by means of controlling the electric drive system in accordance with the invention, a high degree of efficiency is achieved on the one hand in the case of a low power demand while furthermore a sufficient energy reserve is available even for high powers and high rotational speeds. This operating mode is also described as a boost operating mode. Only one relatively small modification of a conventional drive system is required. In contrast to conventional solutions that require a complex transmission, an additional electric machine or similar, the costs, the weight and the volume of the electric drive system are reduced.

In accordance with one embodiment, the inverter comprises a neutral point clamped (NPC) inverter. NPC inverters render it possible in comparison to conventional B6 bridges to double the output voltage when using switching elements with an unchanged proof voltage. In this manner it is possible to control the electric machine in the operating mode with the correspondingly high voltages without having to develop new switching elements that have a higher proof voltage. Corresponding semiconductor switching elements, in particular MOSFET, IGBT, silicon carbide (SiC) or gallium nitride (GaN) switching elements having a sufficient proof voltage are consequently already commercially available. Furthermore, using NPC inverters also renders it possible to reduce the size of the required passive components owing to the higher possible switching frequencies without this having a fundamental effect on the degree of efficiency. Moreover, the malfunction of a switch does not automatically lead to the complete malfunction of the NPC inverter, whereby the availability of the electric drive system can also be increased.

In accordance with a further embodiment, the first electrical energy storage apparatus and the second electrical energy storage apparatus are connected to one another at a junction. This junction is electrically connected to the center connector (neutral point) of the NPC inverter. In this manner, it is possible by way of example to use an electric battery having a center tap as an energy storage device. The center tap in this case represents the junction between the two energy storage apparatuses. It is possible in this manner to achieve the energy supply for the electric drive system in accordance with the invention in a particularly simple manner.

In accordance with one embodiment, the inverter is moreover designed so as in a recuperating mode to rectify an electrical voltage that is provided by the electric machine. This rectified electrical voltage can be provided by means of the inverter at the first electrical energy storage apparatus and/or the second electrical energy storage apparatus. It is possible in this manner to convert kinetic energy into electrical energy by means of the electric machine and to supply this electrical energy to the electrical energy storage device.

In accordance with one embodiment, the first energy storage apparatus and the second energy storage apparatus are constructed differently. By way of example, the first energy storage apparatus can comprise a high energy storage apparatus. High energy storage apparatuses of this type are designed for the purpose of storing a large amount of energy and outputting this energy on demand. In this manner, it is possible to provide by way of example by means of the first electrical energy storage apparatus the required energy for a long term operation of the electric machine. Furthermore, it is possible to embody by way of example the second electrical energy storage apparatus as a high power energy storage device. A high power energy storage device is in particular capable of providing a large amount of electrical energy very rapidly. This electrical energy that is provided can be used for example for an intense accelerating procedure or a short-term operation of the electric machine in the case of a particularly high power. Each of the two energy storage apparatuses can be individually tailored to the respective requirements by means of the different embodiments of the two electrical energy storage apparatuses.

Furthermore, if by way of example during the recuperating procedure, the electrical energy storage device is also charged by means of the inverter, it is thus possible to preferably select in particular one of the two electrical energy storage apparatuses. In this case, the energy storage apparatus that is to be charged during the recuperating procedure can be optimized for an increased number of charging cycles. By way of example, supercapacitors or similar are particularly suitable for this purpose. If during the recuperating procedure the energy storage apparatus is charged, said energy storage apparatus being designed for an increased number of charging cycles, it is thus possible to extend the expected serviceable life of the entire energy storage apparatus.

In an alternative embodiment, the first energy storage apparatus and the second energy storage apparatus are embodied identically. In this manner, the required electrical energy storage device can be achieved in a particularly simple manner.

In accordance with a further embodiment, the first energy storage apparatus comprises a traction battery. The electrical energy storage device for the drive system in accordance with the invention can thus be constructed in a particularly simple manner.

In accordance with one embodiment, the first energy storage apparatus and/or the second energy storage apparatus comprise/comprises a terminal voltage of at least 300 Volts. It is preferred that the corresponding terminal voltage comprises a voltage of approximately 400 Volts. There are already numerous existing components having sufficient proof voltage that are available for voltage levels of this type, such as by way of example traction batteries and NPC inverters. The electric drive system can therefore be constructed in a simple and cost-effective manner in this case.

In accordance with one embodiment, the electric machine is then controlled in the second operating mode if a rotational speed of the electric machine exceeds a predetermined first threshold value and/or a torque that is provided by the electric machine exceeds a predetermined second threshold value. It is possible in each case to select the optimal operating mode by means of switching between the two operating modes in dependence upon the rotational speed of the electric machine and/or the required torque so that on the one hand the electric machine is operated with a high degree of efficiency and furthermore it is also possible to take into account temporarily high power demands.

In accordance with a further aspect the present invention provides a motor vehicle having an electric drive system in accordance with the invention. It is possible by means of integrating an electric drive system in accordance with the invention into a vehicle, such as by way of example a passenger car or however also other motor vehicles, such as by way of example buses or trucks, to provide in each case an efficient drive system over a very broad power spectrum, said drive system in particular also offering a sufficient power reserve when accelerating or at high velocities.

Further embodiments and advantages of the present invention are evident in the description hereinunder with reference to the attached drawings.

### BRIEF DESCRIPTION OF THE DRAWINGS

In the drawings:

FIG. 1 illustrates schematically an electric drive system in accordance with one embodiment,

FIG. 2 illustrates schematically an electric drive system having an NPC inverter in accordance with one embodiment,

FIG. 3 illustrates schematically a motor vehicle having a drive system in accordance with one embodiment,

FIG. 4 illustrates schematically the curve of the torque over the rotational speed of an electric machine, and

FIG. 5 illustrates schematically a method for operating an electric machine, said method forming the basis of one embodiment.

### DETAILED DESCRIPTION

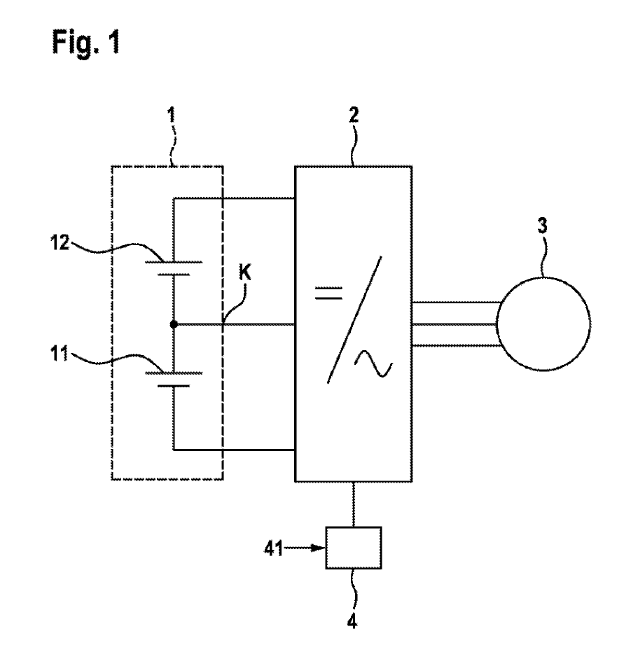

FIG. 1 illustrates schematically an electric drive system in accordance with one embodiment. An electrical energy storage apparatus 1 supplies an inverter 2 with its electrical energy. The inverter 2 converts the direct current voltage that is provided by the electrical energy storage device 1 into a single phase or multi-phase alternating current and controls an electric machine 3 with said alternating current.

The electrical energy storage device 1 can fundamentally be any electrical energy storage device that comprises in addition to the two outer connectors positive and negative a further additional center tap K. By way of example, the electrical energy storage device 1 can be a two-part energy storage device that comprises a first electrical energy storage apparatus 11 and a second electrical energy storage apparatus 12, wherein the first and the second energy storage apparatuses 11 and 12 are electrically connected to one another at a junction. This junction represents in this case the center tap K of the electrical energy storage device 1. In the illustrated example, the positive connector of the first energy storage apparatus 11 is connected to the negative connector of the second energy storage apparatus 12 and said junction is connected to the inverter 2. Moreover, the negative connector of the first energy storage apparatus 11 and also the positive connector of the second energy storage apparatus 12 are connected to the inverter 2. Alternatively, an electrical energy storage device 1 is also possible in which the negative connector of the first energy storage apparatus 11 is connected to the positive connector of the second energy storage apparatus 12.

The electrical energy storage device 1 can be a battery having a center tap K in which the two energy storage apparatuses 11 and 12 in each case are formed by means of one or multiple battery cells. Alternatively, the electrical energy storage device 1 can also be formed by means of two separate batteries, wherein each of the two batteries corresponds to an electrical energy storage apparatus 11 or 12. In this case, the electric connection between the two batteries represents the center tap K.

The terminal voltage of the first electrical energy storage apparatus 11 can correspond precisely or at least approximately to the terminal voltage of the second electrical energy storage apparatus 12. Alternatively, it is likewise possible that the first electrical energy storage apparatus 11 and the second electrical energy storage apparatus 12 comprise different terminal voltages. It is preferred that at least the terminal voltage across the first electrical energy storage apparatus 11 corresponds to the terminal voltage of a conventional traction battery as is used to operate an electric machine by way of example in an electric vehicle. Traction batteries of this type generally comprise a terminal voltage of at least 300 Volts, in particular between approximately 300 and 400 Volts.

The first electrical energy storage apparatus 11 and the second electrical energy storage apparatus 12 of the electrical energy storage device 1 can be constructed identically. Furthermore, it is however also possible for the first energy storage apparatus 11 and the second energy storage apparatus 12 to differ in their construction, or at least in the parameters such as energy storage capacity and/or terminal voltage. By way of example it is possible that the first energy storage apparatus 11 comprises a larger or smaller energy storage capacity than the second energy storage apparatus 12. The first energy storage apparatus 11 can be designed by way of example as a high energy storage device. A high energy storage device of this type can store a large amount of energy in a relatively small storage volume and can provide said electrical energy on demand. The second energy storage apparatus 12 can be embodied by way of example as a high power storage device. A high power energy storage device of this type is capable of providing a large amount of energy within a very short time span, in particular a large amount of electrical energy. Consequently, it is possible by means of such a high power storage device to provide the required electrical energy in a very rapid manner by way of example in the case of a demand for very high power. By way of example, a high power energy storage device of this type can be a supercapacitor or similar. Other storage technologies are however also possible.

Moreover, the two electrical energy storage apparatuses 11 and 12 of the electrical energy storage device 1 can also be optimized for a different number of maximum charging cycles. It is thus possible for example for one of the two electrical energy storage apparatuses 11 or 12 to be optimized for a particularly high number of charging cycles while the in each case other energy storage apparatus 11 or 12 is only designed for a lower number of charging cycles. In this case, in a recuperation mode the electrical energy can preferably be supplied into the energy storage apparatus 11 or 12 that is designed for a higher number of charging cycles. Consequently, the energy storage apparatus 11 or 12 that is designed for fewer charging cycles is not loaded during the recuperating procedure. In this manner, the electrical energy storage device 1 can be embodied in a cost-effective manner for a long serviceable life.

The three connectors of the electrical energy storage device 1, in other words the negative connector, the positive connector and the center tap K are electrically connected to an inverter 2. By way of example, this inverter can be a neutral point clamped inverter (NPC-inverter). The inverter 2 converts the direct current voltage that is provided by the electrical energy storage device 1 into a single or multi-phase alternating current. The electric machine 3 that is electrically connected to the inverter 2 is controlled with this converted alternating current. The inverter 2 can be operated based upon control signals that are generated by a control device 4 and are provided at the inverter 2. The control signals can be generated in the control device 4 by way of example based upon control parameters 41, such as for example a predetermined rotational speed or a torque that is to be provided in the electric machine 3 are calculated.

In a first operating mode, it is possible for the inverter 2 to control the electric machine 3 exclusively using the part voltage of the electrical energy storage device 1, said part voltage being provided by means of the first energy storage apparatus 11. The second energy storage apparatus 12 is not used in this first operating mode to control the electric machine 3. In this first operating mode, the amplitude of the voltage with which the electric machine 3 can be controlled is consequently limited by means of the terminal voltage of the first energy storage apparatus 11. Generally, the voltage that is provided by means of the first energy storage apparatus 11 is sufficient for operating the electric machine 3 in a rotational speed range up to a predetermined threshold. Prior to this threshold for the rotational speed, the electric machine 3 can also be accelerated particularly well when using the voltage that is provided exclusively by the first electrical energy storage apparatus 11. Furthermore, in order to also be able to accelerate the electric machine particularly well at higher rotational speeds or also to be able to provide a sufficient torque at higher rotational speeds by means of the electric machine 3, the electric machine 3 can be controlled by means of the inverter 2 in a further operating mode when using the complete voltage at the electrical energy storage device 1. In this case, the inverter 2 uses an electrical voltage so as to control the electric machine 3, said electrical voltage occurring from a series circuit of the first energy storage apparatus 11 and the second energy storage apparatus 12, and that is applied between the positive and the negative connector of the electrical energy storage device 1. It is possible by means of using this higher electrical voltage for the inverter 2 to also provide an alternating current having an accordingly higher amplitude at the electric machine 3. Consequently, it is also possible to provide a sufficiently large torque at higher rotational speeds by means of the electric machine 3 or it is possible to achieve an improved acceleration of the electric machine 3 even at higher rotational speeds. In this case, it is to be noted that the insulation of the electric machine 3, in particular the insulation of the windings in the electric machine 3 is also embodied with the relevant proof voltage. In other words, it is necessary to adjust the proof voltage of the electric machine 3 to the electrical voltage that occurs between the positive and the negative connector of the electrical energy storage device 1, in other words by means of the series circuit of the first and the second energy storage apparatus 11 and 12. Moreover, it is necessary for the electric drive system, in particular the electric machine 3 and also the inverter 2, to be designed for the high electric power and the heat that is generated in association therewith and can occur in this second operating mode.

The decision whether the inverter 2 controls the electric machine 3 in the first operating mode using the electrical voltage from only one electrical energy storage apparatus 11 or whether the electric machine 3 is controlled using the full electrical voltage of the electrical energy storage device 1 from the first and second energy storage apparatus 11 and 12 can be determined based upon the rotational speed of the electric machine 3 and/or a torque that is to be set at the electric machine 3. As described above, it is sufficient in the case of low rotational speeds or a low torque that is to be set at the electric machine 3 to control the electric machine 3 only using the voltage of the first energy storage apparatus 11. In contrast, in the case of higher rotational speeds and/or higher torques that are to be set, the electric machine 3 is controlled using the electrical voltage from the first and second energy storage apparatus 11, 12. The selection of the respective operating mode can be affected by means of the control device 4 when using the control parameter 41 that is provided at the control device 4. The control device 4 can receive by way of example data regarding a desired rotational speed of the electric machine and also a torque that is to be set at the electric machine and from said data can determine the suitable operating mode. The inverter 2 is subsequently controlled in the operating mode that is determined in this manner.

In addition to the two above described operating modes, a recuperating mode is also possible. In this further operating mode, the electric machine 3 is operated as a generator. This electric machine 3 provides a single phase or a multi-phase alternating current at the inverter 2, said alternating current being converted by means of the inverter 2 into a direct current voltage. The inverter 2 operates in this operating mode in other words as a rectifier. The voltage that is rectified in this manner can furthermore be provided at the energy storage device 1 and can charge the energy storage device 1. It is possible that both the first energy storage apparatus as well as the second energy storage apparatus 12 of the electrical energy storage device 1 can be simultaneously charged. Alternatively, it is possible to only charge one of the two energy storage apparatuses 11 or 12. By way of example, it is possible to only charge the energy storage device 11 or 12 that at the time comprises a lower state of charge. Moreover, it is also possible to preferably charge one of the two energy storage apparatuses 11 or 12. By way of example, one of the two energy storage apparatuses 11 or 12 can be optimized for a higher number of charging cycles. The in each case other energy storage apparatus 11 or 12 can be designed in this case in a cost-effective manner for a smaller number of charging cycles.

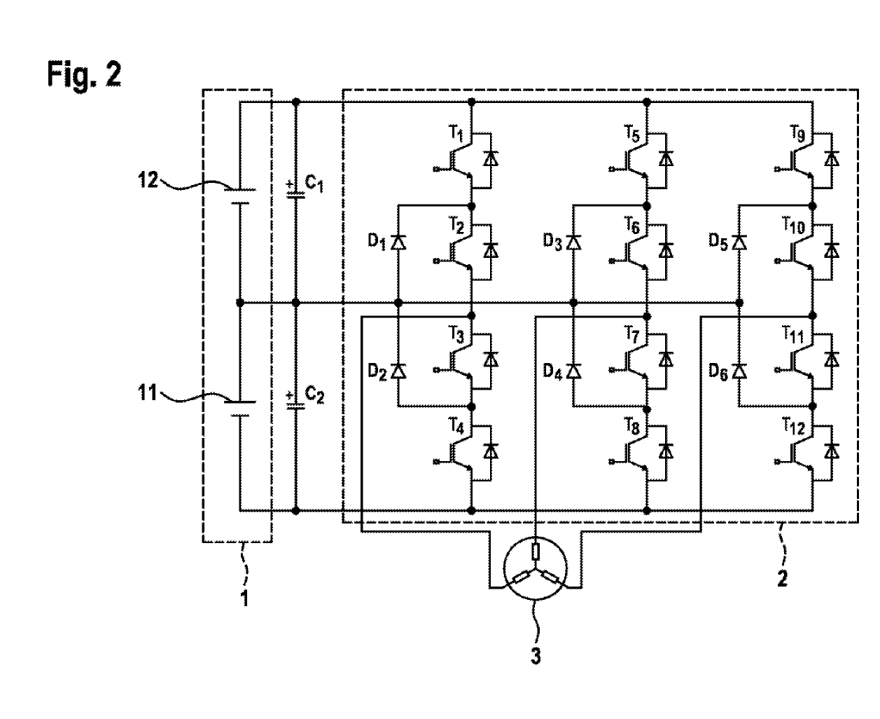

FIG. 2 illustrates schematically an electric drive system in accordance with one embodiment in which the inverter 2 is embodied as an NPC inverter. NPC inverters of this type are particularly suitable as inverters for the above-described electric drive system. An intermediate circuit capacitor C1, C2 is arranged in each case between the center tap K and the positive or negative connector of the electrical energy storage apparatus 1. Each of the three phases of the inverter that is illustrated comprises four semiconductor switching elements T1 to T4, T5 to T8 and T9 to T12. Fundamentally, however, it is possible with the illustrated switching principle to also achieve one of three deviating numbers of phases. For the first phase, the four switching elements T1 to T4 are connected between the positive and the negative connector of the energy storage device 1 in series. The center junction between the second semiconductor switching element T2 and the third semiconductor switching element T3 is connected to a phase connector of the electric machine 3. The junction between the first and the second semiconductor switching element T1, T2, and also the junction between the third and fourth semiconductor switching element T3, T4 are in each case connected by way of a diode D1 or D2 to the center tap K of the electrical energy storage device 1. The construction for the further phases is, as is illustrated in FIG. 2, similar to the above described first phase.

An inverter 2 that is embodied in this manner in the form of an NPC inverter renders it possible to also use conventional switching elements, such as by way of example MOSFET or IGBT but also to use new, rapid switching silicon carbide (SiC) or gallium nitride (GaN) switches.

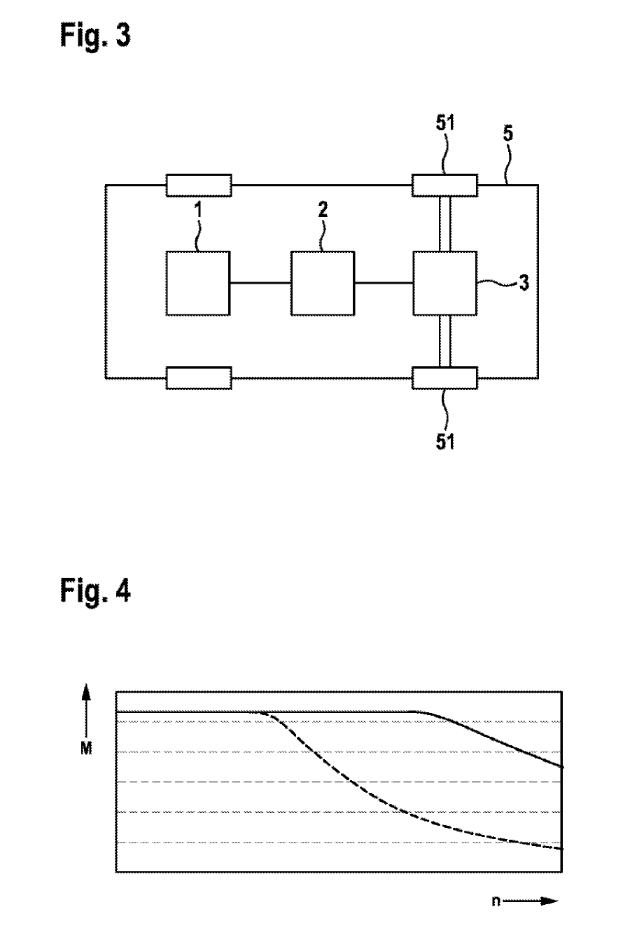

FIG. 3 illustrates schematically an electric vehicle 5 having an electric drive system in accordance with one embodiment. The electrical energy storage device 1 supplies the inverter 2. The inverter 2 furthermore controls the electric machine 3. The electric machine 3 is coupled by way of a transmission and a mechanical connection to the wheels 51 of an axle of the vehicle 5. In dependence upon the rotational speed of the electric machine 3 and consequently the velocity of the vehicle 5, and also the desired acceleration or a torque that is to be set, the electric machine 3 is either controlled with the full voltage that is provided by means of the energy storage device 1 or only with the part voltage between a center tap and an outer connector of the electrical energy storage device 1.

FIG. 4 illustrates schematically a diagram of the torque M that is available over the rotational speed n of an electric machine 3. The dashed curve illustrates the available torque in the first operating mode in which the electric machine 3 is controlled by means of the inverter 2 with only the part voltage from the first electrical energy storage apparatus 11. As is evident, above a threshold rotational speed the available torque decreases. The electric machine 3 and consequently where appropriate also an electric vehicle that is driven with this electric machine 3 can therefore only be fundamentally accelerated at a slower rate. In contrast, when using the full voltage of the electrical energy storage device 1 from a combination of the first energy storage apparatus 11 and the second energy storage apparatus 12, the available torque remains constant above a much higher rotational speed prior to a decrease also being recorded in this case. The electric machine 3 can therefore also be accelerated particularly rapidly when being controlled with the higher electrical voltage over a higher rotational speed range.

The above described electric drive system can be used by way of example for a complete or a part electrically-driven vehicle. In particular, in the case of passenger cars having a relatively high final velocity it is possible to achieve a good acceleration over a particularly large velocity range. It is even possible in the case of high rotational speeds to provide a large torque. Likewise, the above described electric drive system can also be used for any other electric vehicle. By way of example, heavy vehicles, such as for example buses or trucks, can also be controlled during a normal driving operation in one operating mode and during an intense acceleration can be operated in the other operating mode.

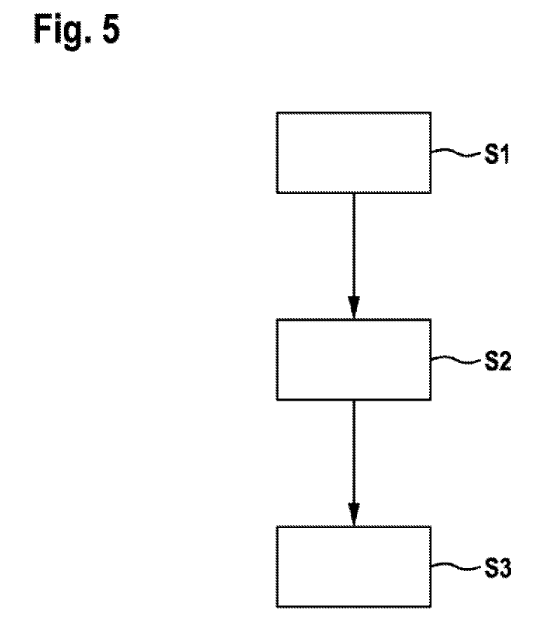

FIG. 5 illustrates schematically a flow diagram that forms the basis of a method for operating an electric machine 3 in accordance with one embodiment. In a first step S1, an electrical energy storage device 1 is provided that comprises a first electrical energy storage apparatus 11 and a second electrical energy storage apparatus 12. The two electrical energy storage apparatuses 11 and 12 are preferably electrically coupled to one another at a common junction K. In step S2, the electric machine 3 is controlled in a first operating mode when using a voltage that is provided by the first energy storage apparatus 11. Furthermore, in a second operating mode in step S3 the electric machine 3 is controlled when using a second voltage that results from a series circuit of the first energy storage apparatus 11 and second energy storage apparatus 12. The electric machine 3 is then controlled in the second operating mode if a rotational speed of the electric machine 3 exceeds a predetermined first threshold value and/or if a torque that is provided by the electric machine 3 exceeds a predetermined second threshold value.

In summary, the present invention relates to an electric drive system and a method for operating an electric machine in which the electric machine is controlled in a first operating mode when using a first voltage. It is possible in order to temporarily increase the power for the electric machine to be controlled moreover in a second operating mode in which the voltage that is used for the control procedure is increased by means of a further energy source.

1. An electric drive system comprising:
an electrical energy storage device (1) including a first electrical energy storage apparatus (11) and a second electrical energy storage apparatus (12),
an electric machine (3), and
an inverter (2) configured to control the electric machine (3) in a first operating when using a first voltage provided by the first energy storage apparatus (11), and to control the electric machine (3) in a second operating mode when using a second voltage that results from a series circuit of the first energy storage apparatus (11) and the second energy storage apparatus (12).

2. The electric drive system as claimed in claim 1, wherein the inverter (2) comprises a neutral point clamped (NPC) inverter.

3. The electric drive system as claimed in claim 2, wherein the first electrical energy storage apparatus (11) and the second electrical energy storage apparatus (12) are electrically connected to one another at a junction (K) and the junction (K) is electrically connected to a center connector of the NPC inverter.

4. The electric drive system as claimed in claim 1, wherein the inverter (2) is configured to rectify, in a recuperating mode, an electrical voltage that is provided by the electric machine (3) and to provide said electrical voltage at the first electrical energy storage apparatus (11) and/or the second electrical energy storage apparatus (12).

5. The electric drive system as claimed in claim 1, wherein the first energy storage apparatus (11) and the second energy storage apparatus (12) are constructed differently.

6. The electric drive system as claimed in claim 1, wherein the first energy storage apparatus (11) comprises a traction battery.

7. A motor vehicle having an electric drive system as claimed in claim 1.

8. A method for operating an electric machine (3), the method comprising:
providing (S1) an electrical energy storage device (1) including a first electrical energy storage apparatus (11) and a second electrical energy storage apparatus (12), controlling (S2) the electric machine (3) in a first operating mode when using a first voltage provided by the first energy storage apparatus (11), and
controlling (S3) the electric machine (3) in a second operating mode when using a second voltage that results from a series circuit of the first energy storage apparatus (11) and the second energy storage apparatus (12).

9. The method as claimed in claim 8, wherein the electric machine (3) is controlled in the second operating mode if a rotational speed of the electric machine (3) exceeds a predetermined first threshold value and a torque that is to be provided by the electric machine (3) exceeds a predetermined second threshold value.

10. The method as claimed in claim 8, wherein the electric machine (3) is controlled in the second operating mode if a rotational speed of the electric machine (3) exceeds a predetermined first threshold value.

11. The method as claimed in claim 8, wherein the electric machine (3) is controlled in the second operating mode if a torque that is to be provided by the electric machine (3) exceeds a predetermined second threshold value.
